(19) United States
(12) Patent Application Publication
(10) Pub. No.: US 2007/0032223 A1
(43) Pub. Date: Feb. 8, 2007

(54) Methods and devices for SMS dialing assistance

(76) Inventor: William P. Alberth JR., Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 11/199,412

(22) Filed: Aug. 8, 2005

(51) Int. Cl. H04M 3/42

(52) U.S. Cl. 455/416; 455/466

(57) ABSTRACT

A device (102) and method for processing a text message, such as a Short Message Service (SMS) message, Enhanced Message Service (EMS) message, Multimedia Message Service (MMS) message, or some other format message, to generate control information usable for another communication. The method includes receiving a message readable by the user (202), processing control information based on the message (204) and transmitting an outgoing communication associated with the control information (210). The method may be carried out, for example, by a communication device including a receiving module (112) for receiving a message readable by the user comprising control information, a processing module (118) for processing the control information, and a communication module (112) for establishing communication with another communication device based on the control information.

### FIELD OF THE DISCLOSURE

This invention relates to the establishment of connections by communication devices, and more particularly, control information for the establishment of connections that are provided in received messages.

### BACKGROUND OF THE DISCLOSURE

Communication devices, and in particular, cellular communication devices provide the ability to communicate in a number of ways. In addition to traditional voice communication, cellular technology provides communication via, for example, Short Message Service (SMS) messaging, Enhanced Message Service (EMS) messaging and Multimedia Message Service (MMS) messaging. Depending upon the circumstances of the communication, communication users may chose one form of communication over another.

For a short communication or one not requiring interaction, a user may chose to send an SMS message. For example, were a user to wish to set up a conference call with another user, the first user may communicate the conference telephone number, the pass code, and other information via an SMS message. The second user, to join the voice conference call, must dial the conference telephone number, and when prompted, dial the pass code, and possibly other information. In such a situation, the second user will either remember the numbers sent to him or her in the SMS message, or will write them down. One or the other of these options may prove difficult. A transcription or reconfiguration of the numbers may therefore be useful.

There are other situations where information provided in a text message, if transcribed or reconfigured, may be more useful. For example, service providers, such as banks or brokers oftentimes use automated menus to allow users to access their account information. Dialing through a menu can be redundant when performed on a regular basis. Were there a manner in which to avoid the redundancy, users may be more likely to use provider's telephone services.

It would be advantageous if communication devices were configured to process messages, such as SMS text messages, to automate dialing and automatically generate subsequent DTMF (dual tone multi-frequency) transmissions.

### BRIEF DESCRIPTION OF THE DRAWINGS

FIG. 1 shows an electronic device capable of communicating with one or more remote electronic devices and with one or more servers.

FIG. 2 is a flow chart for generating and transmitting control data from a first device to a second device.

FIG. 3 is a flow chart of an embodiment of a method for programming an electronic device to automatically process a provider's menu.

FIG. 4 is a flow chart executing a phone book entry to automatically process a provider's menu.

### DETAILED DESCRIPTION

Described is a device and a method for processing a text message, for example, a Short Message Service (SMS) message, Enhanced Message Service (EMS) message, an Multimedia Message Service (MMS) message, or some other format message, to generate control information usable for another communication. The method includes receiving a message readable by the user, processing control information based on the message, and transmitting an outgoing communication associated with the control information. The method may be carried out, for example, by a communication device including a receiving module for receiving a message readable by the user comprising communication control data, a processing module for processing the control information, and a communication module for establishing communication with another communication device based on the control information.

The instant disclosure is provided to further explain in an enabling fashion the best modes of making and using various embodiments in accordance with the invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

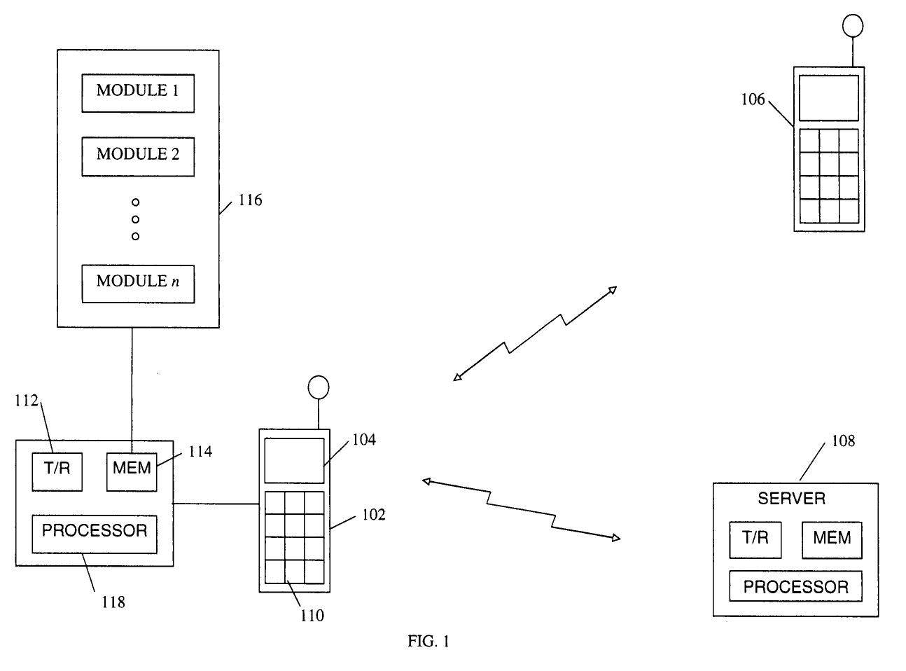

FIG. 1 illustrates an electronic device capable of communicating with one or more remote electronic devices and with one or more servers. In particular situations, text messaging can be used to transmit numerical data such as telephone numbers and passcodes in the form of control information. One situation where a text message may contain such numerical data includes a message to set up a conference call. A caller may send to a recipient, for example, a conference call telephone number and a passcode. The message can be read by the recipient as a text message so that the recipient may also write down or copy in some manner the conference call telephone number and a passcode, if the recipient so chooses. However, to avoid the need to write down or otherwise transcribe the control information, a text message can be translated into its control information that the device may use to automatically execute a telephone call and communicate the passcode. In this way, a call such as a conference call can be easily placed.

In FIG. 1, a communication device 102, here depicted as a cellular telephone, is shown with display device 104 for displaying or annunciating (in any manner) the text message. The communication device may be any type of wireless or wired device including, for example, cellular phones, pagers, radios, personal digital assistants (PDAs), notebook or laptop computers incorporating wireless modems, mobile data terminals, application specific gaming devices, video gaming devices incorporating wireless modems, standard or digital landline telephones, etc. The communication device can communicate by wireless networks and wires. Examples of wireless networks are cellular telephone networks, pager networks, and Internet networks. Such wireless networks may include land lines, radio links and satellite links, and may be used for such purposes as cellular phone systems, Internet systems, computer networks, pager systems and other satellite systems.

FIG. 1 further shows one or more remote electronic devices 106 and one or more servers 108. The electronic device 106 or the server 108 may be responsible for sending the text message to electronic device 102. Moreover, the electronic device 102 may communicate a response to the text message to electronic device 106 and/or server 108.

The electronic device 102 includes a transmitter/receiver 112 for receiving the text message and for establishing communication with another device such as communication device 106 and/or server 108. The electronic device 102 further can include a memory 114 with instruction modules 116 and a processor 118 for processing the instructions, including those for generation of executable commands from the control information. Likewise, communication device 106 can include the same components, as does the server 108.

As an example, the text message received by electronic device 102 may read as follows: “hi roger the team will have a conf call at 12 noon today, 18006432767 pc 51234”

The text message is displayed on display device 104. At the appointed time, a call into a conference call may be placed either by the recipient manually or by the telephone automatically. In a manual manner, at 12 noon, the recipient can provide input to the telephone to place the call by the keypad 110 or provide input in another manner such as voice controls. Were the communication device 102 to place the call itself without user input or automatically at noon, the telephone can access its own clock and then can alert the user that it is placing the call or has placed the call.

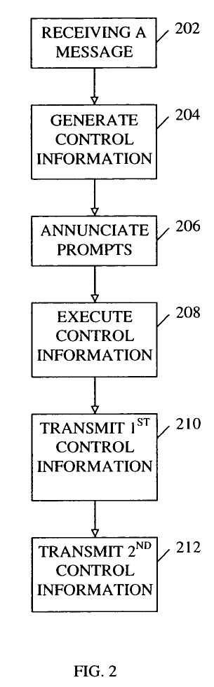

FIG. 2 is a flow chart of an embodiment of a method for processing from control information, executable commands to place a call from a first device to a second device. Upon receipt of the message 202, the device processor will retrieve instructions from the memory to process or generate control information 204 either automatically or by prompt. The method as described herein includes retrieving from the text message certain fields that form control information that can be used to establish communication with another device. In the example above, the control information includes “12 noon today, 18006432767 pc 51234.” In this example, there are 4 different fields of control information. “12 noon” is a time, “today” is a date, “18006432767” is the telephone number and “51234” is the passcode.

The four different fields forming control information may be identified by instructions of the communication device automatically, or may be identified by the user in response to prompts. In FIG. 2, a step of annunciating prompt 206 is optional. The annunciating step can take any form such as the user highlighting certain fields of the text message when asked to identify the field. In any event, the time, date, telephone number and passcode can be translated from control information into executable commands that can include at least one of the following: digits that are transmitted as DTMF, commands interpreted as pauses and commands interpreted as requiring user input.

In the event that the text message does not include all the information needed to enter a conference call, for example, additional executable commands may be entered by the user. The prompts during the execution of the telephone call may include the option for the user to insert into the message additional control information not sent in the text message. For example, for security, the user may have his/her own personal secret passcode not sent by the sender of the text message. However, to establish communication, the secret passcode must be transmitted. Therefore, the user may add control information when prompted or otherwise, to establish communication.

Furthermore, the received order of the fields may be different than that which is required for execution. In the example, the sender includes at “12 noon today.” However, the execution of the communication may require that the fields be in the following order: “today” and then “12 noon.” Accordingly, the reordering of the control information can be performed before transmitting the outgoing communication either manually, by prompt, or automatically.

Alternatively, a blank message boilerplate may be available for generating the original text message. For example, the empty preformatted message could contain the following fields to fill in: <recipient><name><from><participants><date><time><telephone number to call><passcode>. The preformatted message shell could be downloaded to a user's telephone or installed at manufacture.

In this manner, the fields would be in the right order to provide a connection. Furthermore, pauses could be inserted into the text message format. For example, a pause could be inserted between the telephone number and the passcode in the following manner: <telephone number>PAUSE<passcode>.

Either automatically, by prompt, or by user control, the execution of commands generated by the control information 208 can be used to establish communication 210 by transmitting the telephone number and then connect, for example, to a conference call 212 by transmitting a passcode.

The same or similar device and method described above can also be used to preprogram a user's communication device to negotiate with a provider's menu. As an example, service providers, such as banks or brokers oftentimes use automated menus accessible via a telephone to allow users to access their account information. However, dialing through a menu can be redundant when performed on a regular basis. Potentially, a service provider may offer customers preconfigured instructions in the form of a message, such as a text message, to access their own accounts via their communication device. Menu items to which a user must respond include, for example, “for business account information, touch 1, for personal account information, touch 2.” The preformatted message from a provider may include fields such as:
<telephone number>PAUSE <1>PAUSE <2>PAUSE
<passcode>PAUSE <1>PAUSE <3>PAUSE <1>Accordingly, inputting all of the responses required to arrive at the desired place in the menu may take substantial time. Users may be more inclined to use a provider's telephone menu options if they could eliminate some or all redundancy of repeating the process each time they called the provider.

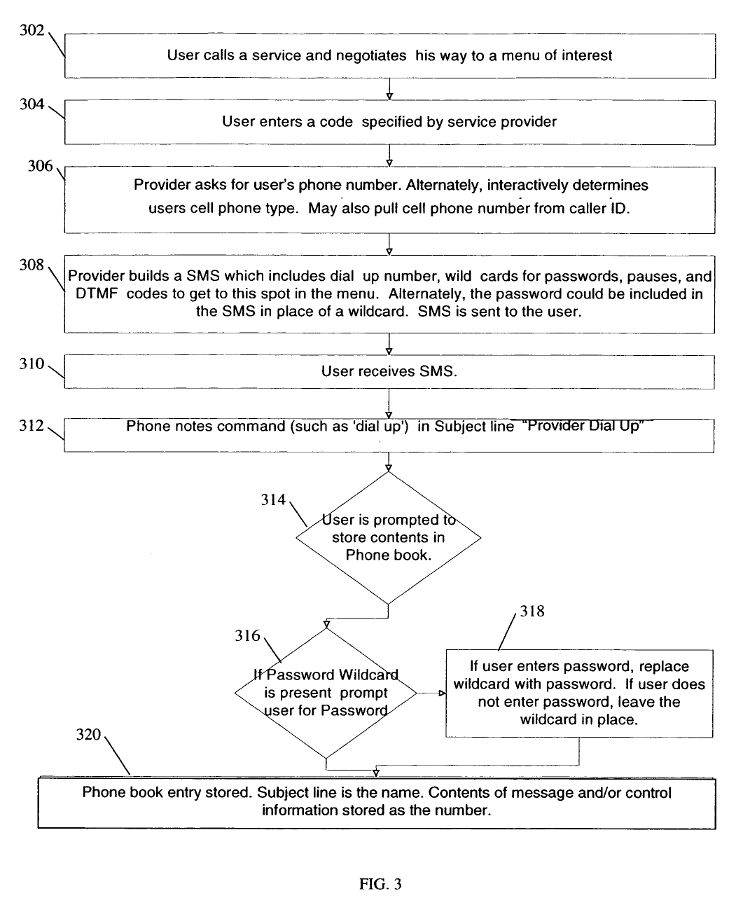

The electronic device may be programmed in a number of different ways to process the menu of a provider without any or too much input by the user. FIG. 3 is a flow chart of an embodiment of a method for programming an electronic device to automatically process a provider's menu. Initially, the user may call the service provider and negotiate through the menu 302. The provider may ask for the user's telephone number or receive it via caller ID 304. Further information may be provided such as the type of cell phone used by the user 306. The provider can then build a text message readable by the user which includes fields having control information as described above, or different ones, including a wild card for passwords, pauses, and DTMF codes to reach a particular point in the menu. Alternatively, a password could be included in place of a wildcard. After construction by the provider, the text message is sent to the user 308. The user receives the SMS 310. The communication device 102 notes the type of command (such as dial up) included in the SMS 312 and prompts the user 314.

There may be many different manners in which to carry out the above-described method so that there may be additional steps or some steps may be eliminated. For example, the provider may send a password wildcard, and the method may include prompting the user for the password 316. If the user enters the password, the instructions replace the wildcard with a password. If the user does not enter a password, the wildcard is left in place 318. The user may store the SMS contents in the phone book 314. The user may access the SMS in the telephone book having a subject line “provider dial up” 320.

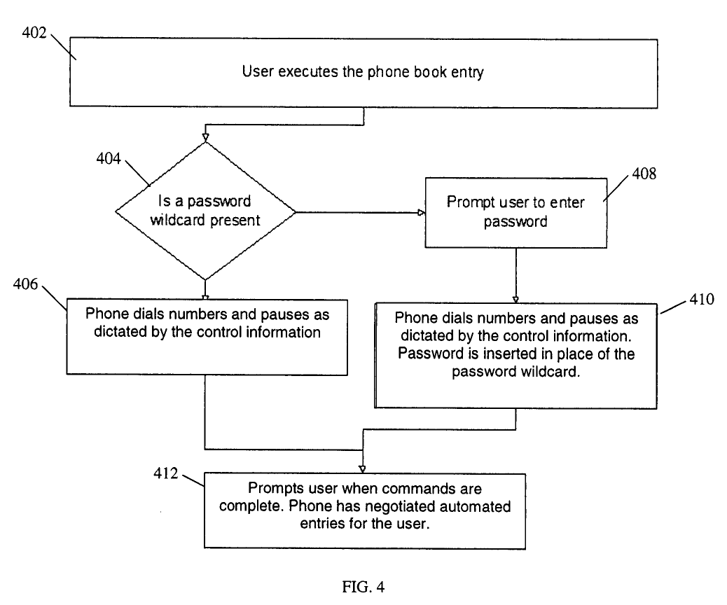

FIG. 4 is a flow chart of an embodiment of a method where a user executes a phone book entry to automatically process a provider's menu. For example, the user may execute the phone book entry “provider dial up” 402. There can be a query as to whether there is a password wildcard present 404. If not, the communication device can dial numbers and pauses as dictated by the control information 406. If the answer is yes to query 404, then the communication device prompts the user to enter the password 408. The device dials numbers and provides pauses as dictated by the control information. The password is inserted in place of the password wildcard 410. It is also possible for the password information to be fingerprint information, picture information (such as facial recognition), voice print data, or other biometric or security data or code. Accordingly, the process may be partially manual and partially automatic. The device can prompt the user when the some or all of the commands of the control information are executed. The process has accordingly negotiated the menu for the user 412, reducing or avoiding the redundancy of interacting with automated menus.

In either case, where the user receives a message with the control information preformatted, or receives a non-formatted message, for example, with the control information out of order, the electronic device may use the control information to generate executable commands to make connections and make responses. In any case, the control information is supplied by a message such as a text message that can be readable by the user. Accordingly, the user avoids inputting the control information into the communication device via the keypad 110 or other input device in making conference calls or negotiating provider menus.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method of a communication device, comprising:
receiving a message readable by the user;
processing control information based on the message;
transmitting an outgoing communication associated with the control information.

2. A method as recited in claim 1 wherein control information includes at least one of the following: digits that are transmitted as DTMF, commands interpreted as pauses, and commands interpreted as requiring user input.

3. A method as recited in claim 1 further comprising:
inserting into the message additional control information provided by the user.

4. A method as recited in claim 1 wherein the control information includes executable commands, the method further comprising:
ordering the executable commands before transmitting the outgoing communication.

5. A method as recited in claim 1 comprising:
transmitting a pass code associated with control information after transmitting the outgoing communication.

6. A method as recited in claim 5 wherein the pass code is for one of the following:
admitting the user to a conference call; and
accessing a menu.

7. A method as recited in claim 1 wherein receiving the message comprises:
receiving a preformatted message.

8. A method as recited in claim 1 wherein receiving the message comprises:
receiving an SMS text message.

9. A method as recited in claim 1 further comprising:
annunciating a prompt to a user to execute a command associated with the control information.

10. A communication device, comprising:
a receiving module for receiving a message comprising control information;
a processing module for processing the control information;
a communication module for establishing communication with another communication device based on the control information.

11. A device as recited in claim 10 wherein the control information comprises:
a telephone number; and
a conference call pass code.

12. A device as recited in claim 10 wherein the control information comprises:
responses to menu inquiries.

13. A device as recited in claim 10 wherein the message is a preformatted message.

14. A device as recited in claim 10 wherein the message is an SMS text message.

15. A device as recited in claim 10 further comprising:
an annunciation module for annunciating the control information to prompt a user to execute a plurality of executable commands.

16. A device as recited in claim 10 wherein the device is a cellular telephone.

17. A communication terminal, comprising:
a reception module for receiving a message;
a processing module for processing the message to generate control information including a command;
a display module for displaying the content of the message;
an execution module for executing the command;
a transmission module for transmitting an outgoing communication upon execution of the command.

18. A terminal as recited in claim 17 wherein the control information comprises:
a telephone number; and
a conference call pass code.

19. A terminal as recited in claim 17 wherein the plurality of control information comprises:
responses to menu inquiries.

20. A terminal as recited in claim 17 wherein the message is readable by the user telephone.

21. A terminal as recited in claim 17 wherein the terminal includes at least one additional input/output peripheral and the message includes commands which cause the terminal to send information derived from the peripheral.
